(19) United States
(12) Patent Application Publication
(10) Pub. No.: US 2021/0165894 A1
(43) Pub. Date: Jun. 3, 2021

(54) STORING NUMERICAL IDENTIFIERS IN DATA STRUCTURES

(71) Applicant: Hewlett-Packard Development Company, L.P., Spring, TX (US)

(72) Inventors: Thalia May Laing, Bristol (GB); Joshua Serratelli Schiffman, Bristol (GB); Gaëtan Wattiau, Bristol (GB); Jonathan Griffin, Bristol (GB)

(73) Assignee: Hewlett-Packard Development Company, L.P., Spring, TX (US)

(21) Appl. No.: 17/047,326

(22) PCT Filed: Jun. 15, 2018
(86) PCT No.: PCT/US2018/037780

§ 371 Date: Oct. 13, 2020

(51) Int. Cl. G06F 21/60; G06F 21/62; G06F 21/31

(52) U.S. Cl. CPC G06F 21/606; G06F 21/6227; G06F 2221/2151; G06F 2221/2137; G06F 21/31

(57) ABSTRACT

An apparatus is disclosed. The apparatus may comprise a storage medium to store: a first data structure to receive a first plurality of numerical identifiers, each numerical identifier of the first plurality of numerical identifiers corresponding to a respective signal received during a first defined time interval; and a second data structure to receive a second plurality of numerical identifiers, each numerical identifier of the second plurality of numerical identifiers corresponding to a respective signal received during a second defined time interval, wherein the first defined time interval is earlier in time than the second defined time interval. The apparatus may comprise a processor. Upon expiry of a defined time period, the processor is to: delete the first data structure; and provide a third data structure to receive a third plurality of numerical identifiers, each numerical identifier of the third plurality of numerical identifiers corresponding to a respective signal received during a third defined time interval occurring after the second defined time interval. A method and a machine-readable medium are also disclosed.

### BACKGROUND

Replay attacks are a form of network attack in which a valid data transmission is maliciously repeated or delayed. Replay attacks are common attacks that can be performed over any network and can be carried out by either the sender or an adversary who intercepts the data transmission and re-transmits it.

### BRIEF DESCRIPTION OF DRAWINGS

Examples will now be described, by way of non-limiting example, with reference to the accompanying drawings, in which:

FIG. 1 is a simplified schematic of an example of an apparatus for storing numerical identifiers in data structures;

FIG. 2 is a simplified schematic of an example of a process by which data structures are managed;

FIG. 3 is a flowchart of an example of a method of storing numerical identifiers in data structures; and

FIG. 4 is a simplified schematic of an example of a machine-readable medium and a processor.

### DETAILED DESCRIPTION

One way of attempting to prevent a replay attack on a network device is to assign a unique signal identifier, also referred to as a number used just once or nonce, to each transmission or signal sent via the network to the network device, and to store the individually assigned signal identifiers, or nonces. When a subsequent transmission is received, the system may verify the validity of the transmission before accepting the transmission. In the verification process, the nonce associated with the received transmission is checked against the stored nonces to determine if a signal having the same nonce has been received before. If a search of the received nonces reveals that the nonce has been used before, it may be suspected that the transmission is being sent as part of a replay attack and, thus, the transmission is rejected. If the nonce associated with the new transmission does not match one of the stored nonces, then the system accepts the transmission as valid and stores the associated nonce for use in subsequent verification processes.

The present disclosure relates to an apparatus capable of managing data structures that may be used to store numerical identifiers, corresponding to nonces.

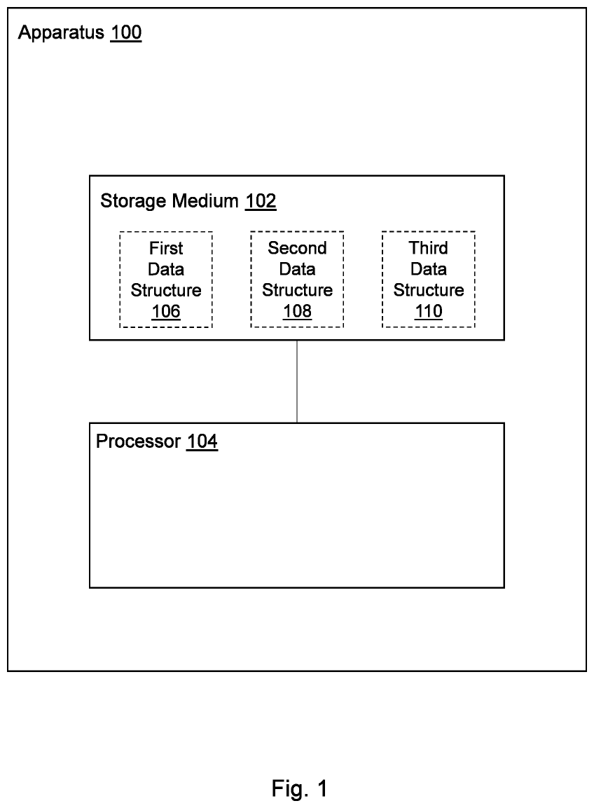

FIG. 1 illustrates a simplified schematic of an example of an apparatus 100. The apparatus 100 may, in some examples, be considered an apparatus for data structure management. The apparatus 100 comprises a storage medium 102 and a processor 104. The storage medium 102 may store a first data structure 106 to receive a first plurality of numerical identifiers. Each numerical identifier of the first plurality of numerical identifiers may correspond to a respective signal received during a first defined time interval. The storage medium, in some examples, may store a second data structure 108 to receive a second plurality of numerical identifiers. Each numerical identifier of the second plurality of numerical identifiers may correspond to a respective signal received during a second defined time interval. In some examples, the first defined time interval may be earlier in time than the second defined time interval. The processor 104 may, upon expiry of a defined time period, delete the first data structure 106 and may provide a third data structure 110 to receive a third plurality of numerical identifiers. Each numerical identifier of the third plurality of numerical identifiers may correspond to a respective signal received during a third defined time interval occurring after the second defined time interval. The data structures 106, 108, 110 are shown having dashed lines to indicate that the data structures may not all be provided at the same time.

The storage medium 102 may store multiple data structures, including the first, second and/or third data structures 106, 108, 110. In some examples, the first, second and/or third data structures 106, 108, 110 may be probabilistic data structures. An example of a probabilistic data structure is a Bloom filter. Another example of a probabilistic data structure is a cuckoo filter. Data structures according to such examples comprise properties that may be utilized in the present disclosure. For example, such data structures can store a plurality of numerical identifiers. In some examples, each numerical identifier of the first, second and/or third data structures 106, 108, 110 may correspond to a portion of a signal identifier included in a respective received signal. In some examples, the numerical identifier to be stored in the data structure may comprise a part (e.g. half, quarter or some other proportion) of the signal identifier included with the transmission. In this way, less space may be used to store the numerical identifier than would be used to store the entire signal identifier. In some examples the numerical identifier may comprise half the number of bytes than the signal identifier. An example of such a signal identifier may be a nonce. Therefore, in some examples, each received signal may comprise a respective nonce, and a numerical identifier corresponding to a received signal may comprise at least a portion of the respective nonce. In some examples, a numerical identifier (or portion thereof) may comprise an output of an operation performed on a corresponding signal identifier. For example a mathematical function could be applied to the signal identifier to compute the corresponding numerical identifier. One example of a mathematical function is a hash function. In one example a hash function may be applied to a nonce to produce a corresponding numerical identifier (or portion thereof) to be stored in a data structure. A portion of a nonce may be referred to as a fingerprint of the nonce. Storing a fingerprint of a nonce may save storage space compared to storing an entire nonce.

Data structures, such as those described above, may also comprise functionality that may be employed in the present disclosure. For example, the structure may comprise a ‘search’ function that can be used to search the content of the given data structure, to determine whether a given element is comprised in the content of the structure. The search function of a data structure, according to some examples, may return one of two results. The result may be either ‘possibly comprised in the data structure’ or ‘definitely not comprised in the data structure’. In the case of a result of ‘possibly comprised in the data structure’ the result may return a false positive (i.e. the data structure may indicate that a searched for element is possibly in the structure, while, on inspection, the searched for element is not present). Thus, determining that the signal identifier corresponds to a numerical identifier in a data structure may comprise determining that the signal identifier possibly corresponds to a numerical identifier in a data structure. Data structures outputting such a probabilistic search result may comprise fast searching capabilities and reduced storage space compared to other data structures. The number of false-positive results can be dependent on a number of factors, such as the total number of entries comprised in the data structure. Another example of a factor is the size of the stored numerical identifier portion. In some examples, a data structure may comprise an ‘add’ function. This function may be used to add an element to the content of a given data structure.

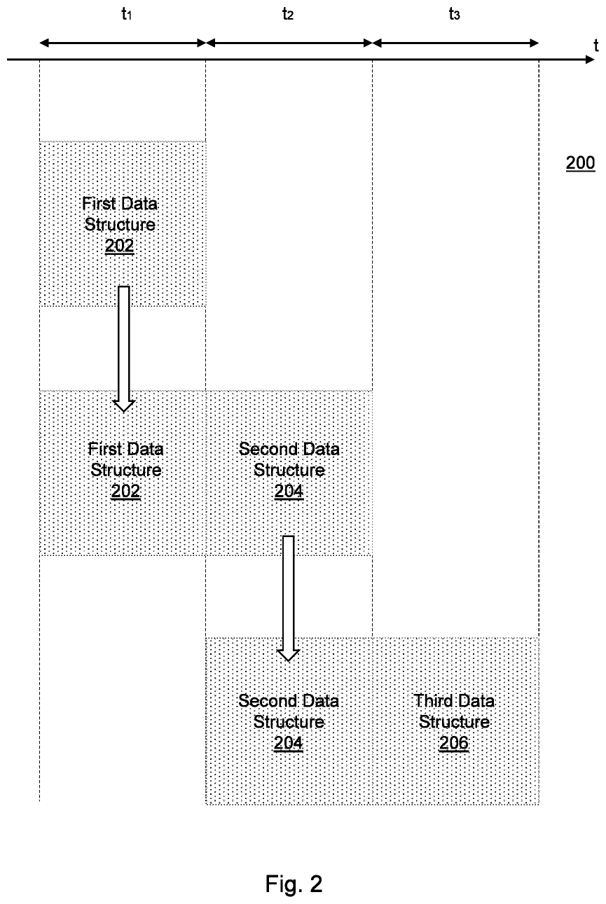

FIG. 2 illustrates a simplified schematic of an example of a process 200. The process 200 may be used to manage data structures. In some examples, the process 200 may be performed by the apparatus 100, for example using the storage medium 102. In other examples, process 200 may be implemented by the processor 104. FIG. 2 illustrates the process 200 occurring over time, indicated by an axis labelled ‘t’. FIG. 2 illustrates three defined time intervals: t₁, t₂ and t₃, corresponding to first, second and third defined time intervals, respectively. In one example during the first defined time interval t₁, a first data structure 202 may be provided. The first data structure 202 may comprise or be similar to the first data structure 106. During the second defined time interval t₂, a second data structure 204 may be provided. The second data structure 204 may comprise or be similar to the second data structure 108. During the second defined time interval t₂, the first data structure 202 may be maintained according to the process 200. In some examples, maintaining the first data structure 202 may comprise providing or storing the first data structure 202 during the second defined time interval t₂. Upon expiry of a defined time period, the first data structure 202 may be deleted and a third data structure 206 may be provided. The third data structure 206 may comprise or be similar to the third data structure 110. During the third defined time interval t₃, the third data structure 206 may be provided. Additionally during the third defined time interval t₃, the second data structure 204 may be maintained by the process 200. In some examples, maintaining the second data structure 204 may comprise providing or storing the second data structure 204 during the third defined time interval t₃. However, first data structure 202 may no longer be maintained as it may have been deleted upon expiry of the defined time period. In the process 200, the defined time period may dictate when the first data structure 202 is deleted and the third data structure 206 is provided. In some examples, the defined time period may comprise the first, second and/or third defined time interval ti₁₋₃. In some examples, the defined time period, the first defined time interval t₁, the second defined time interval t₂ and the third defined time interval t₃ may be substantially the same length.

In one example, the process 200 may involve storing a set of data structures; each data structure may correspond to a respective defined time interval of a plurality of defined time intervals. The first, second and/or third data structures 202, 204, 206, when provided by the process 200, may form part of the set of data structures that may correspond to a set of respective time intervals. Thus, according to one example, during the defined time interval t₁, the first data structure 202 may form part of the set of data structures. During the defined time interval t₂, the first data structure 202 and the second data structure 204 may form part of the set of data structures. During the third defined time interval t₃, the second data structure 204 and the third data structure 206 may form part of the set of data structures. According to some examples, the processor 104, based on the defined time period, is to periodically delete an oldest data structure of the plurality of data structures, which may correspond to an oldest defined time interval of the plurality of defined time intervals. For example, the oldest data structure may correspond to the first data structure 202. The first defined time interval t₁ may correspond to an earliest occurring defined time interval of the set of respective defined time intervals. The processor 104 may provide a new data structure to the plurality of data structures, which may correspond to a latest (e.g. a most recent) time interval forming part of the plurality of defined time intervals. The new data structure may, for example, correspond to the third data structure 206, which corresponds to the third defined time interval t₃.

Thus, according to some examples, over a plurality of time intervals, the processor 104 may periodically delete the oldest data structure and provide a new data structure, governed by the defined time period. Such examples illustrate a process of data structure management where the oldest data structure is automatically deleted and a new data structure provided. This process may therefore efficiently remove an oldest data structure and provide a new data structures to a set of data structures. This process may be automatic, governed by a defined time period and may not involve any additional processing. The first, second and third defined time intervals t₁, t₂, t₃ may be illustrative of a section of a continuous process that may take place over any length of time. Thus, in some examples, the described process may be ongoing, and the processor 104 may periodically delete the oldest data structure from the set and provide a new data structure to the set. In some examples, the first defined time interval t₁, the second defined time interval t₂ and the third defined time interval t₃ may be consecutive intervals of time (i.e. occurring consecutively in time).

The first, second and third data structures, 202, 204, 206 may be to receive a respective plurality of first, second and third numerical identifiers. Each numerical identifier of the first, second and third pluralities may correspond to a respective signal received during the first, second and third defined time intervals t₁, t₂, t₃, respectively. Thus, according to such examples, numerical identifiers associated with signals received during the first defined time interval t₁ may be stored in the first data structure 202, and numerical identifiers associated with signals received during the second defined time interval t₂ may be stored in the second data structure 204. Although the first data structure 202 may be maintained during second defined time interval t₂, numerical identifiers associated with signals received during the second defined time interval t₂ may not be stored in first data structure 202. Numerical identifiers associated with signals received during the third defined time interval t₃ may be stored in the third data structure 206. Although the second data structure 204 is maintained during the third defined time interval t₃, numerical identifiers associated with signals received during the third defined time interval t₃ may not be stored in the second data structure 204.

Thus, in some examples, the process 200 may be used for reducing the occurrence of, or preventing replay attacks. The process 200 may include a verification process for determining the validity of a received signal to verify whether a transmission is genuine or a replay attack. In some examples, a received signal may include data and a time indication element indicating a time at which the signal was sent. In some examples, the time indication element may comprise a timestamp. The time indication element can be used to determine the validity of the received signal. For example, upon receiving, during the second time interval t₂, a signal including data and a time indication element, the processor 104 may determine whether the time at which the signal was sent corresponds to a time in the first defined time interval or the second defined time interval. Responsive to determining that the time at which the signal was sent does not correspond to a time in the first defined time interval or the second defined time interval, the processor may reject the signal.

In one example, the defined time intervals may be set or chosen based on an error or difference between a clock associated with the apparatus 100 and a clock associated with a signal device sending the signal to the apparatus 100. In other examples the defined time period may be set or chosen based on error or difference between a clock associated with the apparatus 100 and a clock associated with a signal device sending the signal to the apparatus 100. When introducing a time indication element into a signal transmission, a synchronization of clocks may take place between the transmitter and the receiver. Performance and accuracy of a particular device's clock can vary substantially and, therefore, the clock associated with the device sending the signal and the clock associated with the apparatus 100 may vary greatly. However, this issue may be overcome by specifying a suitable time error for a given system.

In some examples, when a time indicated by the time indication element is outside a time interval corresponding to a currently provided data structure being stored in the storage medium, this may be indicative of an invalid or replayed signal, which may indicate a replay attack. In such examples, the signal may be rejected. In examples where the defined time period is based on an error or difference between a clock of the apparatus 100 and a clock associated with a signal device sending the signal to the apparatus 100, the first data structure 202 or the oldest data structure in a set of data structures may be deleted based on this defined time period. Therefore, upon expiry of the defined time period, all of the numerical identifiers stored in the oldest data structure may be invalid as the time at which they were received falls outside of the error between the two clocks. By deleting a plurality of numerical identifiers in this way, older, invalid numerical identifiers (i.e. numerical identifiers corresponding to times falling outside of the time intervals corresponding to the stored data structures) which are no longer to be used are not stored, thereby making more storage space available.

In some examples, the process 200 may be used to prevent replay attacks where the received signal includes a signal identifier associated with the received signal. In one example, the signal identifier may be a nonce. The signal may include a time indication element indicating a time at which the signal was sent. In one example the time indication element may be a timestamp. The signal may also include data. In one example, upon receiving such a signal during the second defined time interval, the processor 104 may be to determine whether the time at which the signal was sent corresponds to a time in the first defined time interval t₁ or the second defined time interval t₂. Responsive to determining that the time at which the signal was sent corresponds to a time in the first defined time interval t₁ or the second defined time interval t₂, the processor 104 may search the first data structure 202 and the second data structure 204 for a numerical identifier corresponding to the signal identifier. Thus, as the time the signal was sent is within the first or second time intervals t₁, t₂, the process determines that the time indication element is valid and it may proceed to the next part of the process of searching each data structure. In one example, the first and second data structures 202, 204 may comprise a search function, and the search function for each structure may be used to search the content of each structure. The search function for each data structure may, for example, be performed simultaneously. In one example, a numerical identifier stored in a data structure may comprise a fingerprint (e.g. a portion) of a nonce. Responsive to determining that the signal identifier corresponds to a numerical identifier in either the first data structure 202 or the second data structure 204, the processor may reject the signal. In some examples, determining that the signal identifier corresponds to a numerical identifier in the first or second data structures may involve determining that the signal identifier possibly corresponds to a numerical identifier in either the first or second structures. For example, as noted above, when the data structure comprises a Bloom or a Cuckoo filter, these structures may return a result that the searched-for signal identifier may possibly correspond to a numerical identifier stored in the data structure. The numerical identifiers stored in each data structure correspond to previously received and verified signals. When a signal identifier is received and is found to correspond (or may correspond) to one of the stored numerical identifiers it may be determined that a previously-received signal has been replayed or retransmitted. In some examples, this may be indicative of a potential replay attack. Thus, in such examples the signal may be rejected.

In another example, responsive to determining that the signal identifier does not correspond a numerical identifier in the first data structure 202 or the second data structure 204, the processor may add a new numerical identifier corresponding to the signal identifier of the received signal to the second data structure 202. In some examples, the second data structure may comprise an add function that may be used to add the new numerical identifier to the data structure. Such a function may, for example, be performed, instigated or implemented by a processor (e.g. the processor 104). When it is determined that the signal identifier does not correspond to a numerical identifier stored in a provided data structure, the signal may be verified as a valid signal transmission, which may not be indicative of a potential replay attack. The data of the signal may then be received and processed to establish the transmission. As the signal in such an example may be considered verified, a numerical identifier corresponding to the signal identifier associated with the verified signal may be added to the second data structure 204 (e.g. the data structure corresponding to the latest time interval). Thus, in some examples, when subsequent signals are received and the verification process is performed on the subsequent signals, the signal identifier associated with the subsequently-received signal will be checked against the stored numerical identifiers, including the newly-stored numerical identifier to determine if the subsequently-received signals have been replayed.

Thus a system in accordance with the present disclosure can be used to help provide secure messaging in a network. The described examples may provide data structures that can receive numerical identifiers corresponding to previously-received and verified signal transmissions. Subsequently-received signals comprising signal identifiers that may correspond to numerical identifiers previously-received by the data structures may be indicative of replayed (e.g. maliciously resent) signals. The described examples may provide a system that may identify such signals as replayed and may reject such signals. In some examples, the disclosed system may allow valid and verified signals access to a network, which may aid the provision of secure messaging in the network.

Examples have been described in relation to a signal received during the second defined time interval t₂. However, it will understood that signals received during the first defined time interval t₁ or the third defined time interval t₃ may undergo a similar process to the previously-described examples. It will further be understood that, in the example where the defined time intervals t₁, t₂, t₃ represent a portion of a continuous time period, a signal received during any defined time interval of the continuous time period may undergo a similar process in accordance with the above-described examples.

As noted above, FIG. 2 illustrates an example of process 200, which may be used for data structure management. In one example, during defined time interval t₁, a single first data structure 202 may be provided. At subsequent defined time intervals t₂ and t₃, two data structures may be provided, e.g. the first and second data structure 202, 204 and the second and third data structure 204, 206, respectively. Therefore, according to this example, it will be appreciated that during subsequent defined time intervals following the third defined time interval t₃, two data structures may be provided during each time interval. During each defined time interval, a data structure will be provided for receiving numerical identifiers during the presently-occurring time interval. An additional data structure may be provided that received numerical identifiers during the defined time interval immediately preceding the presently-occurring time interval for cross-checking against previously-received numerical identifiers that were received within the defined time period.

In some examples, a set of data structures may be provided during a given defined time interval. In some examples, the set of data structures may comprise more than two data structures. For example, during defined time interval t₃, the third data structure 206, second data structure 204 and first data structure 202 may be provided. In this example the defined time period may be extended such that numerical identifiers received during the first defined time interval t₁ are within the defined time period and may be used for searching during verification of a signal received during the third defined time interval t₃. In such an example, the error between a clock associated with the apparatus 100 and a clock associated with a signal device sending a signal to the apparatus 100, may be relatively large. Therefore, according to such examples, the defined time period may be set to accommodate this error. In some examples, this may involve a larger number of data structures associated with prior-occurring defined time intervals to be maintained and searched during a given defined time interval.

In some examples, the defined time interval associated with each data structure may be reduced. In such examples, any number of data structures may be provided for a given time interval. For example, separate data structures may correspond to t₁/2 and t₂/2. In such an example, twice the number of data structures provided during second defined time interval t₂ of the illustrated process 200 may be provided, i.e. four data structures. However, the defined time intervals could be reduced to any length of time. In such examples the oldest data structure provided in the set of maintained data structures may be deleted upon expiry of the defined time period. In such examples, a new data structure may be provided to the set corresponding to the most recent reduced defined time interval.

In some examples, by using a shorter defined time interval, data structures may be deleted more frequently. Using a shorter defined time interval may lead to more data structures being provided for a given defined time interval than for a longer defined time interval. Using a shorter defined time interval associated with each data structure may increase the granularity of the arrangement. For example, with shorter defined time intervals, a greater number of data structures would be used, and data structures would be deleted and provided more frequently. When the data structure receives numerical identifiers corresponding to respective received signals, this may increase the granularity with which older numerical identifiers corresponding to signals received during older time intervals may be deleted.

In some examples, the number of received signals during a defined time period may be relatively large. If the data structure receiving numerical identifiers associated with the received signals uses a search function that may return a false positive, the number of numerical identifiers stored in the data structure may cause the data structure to return an unacceptably high rate of false positive results. In such an example, reducing the duration of the defined time interval for a data structure may reduce the number of numerical identifiers in the structure and may reduce the rate of false positive results. In other examples, the time error between a clock associated with apparatus 100 and a clock associated with a device sending a signal may be relatively large. In such an example, a large number of signals may be received during the defined time period and may cause similar negative effects in the data structures provided during the defined time period, such as an unacceptably high rate of false positive results. In such examples, reducing the defined time interval corresponding to each data structure may reduce these effects.

In some examples, the process 200 may be dynamic. In one example, a duration of the first defined time interval t₁ may be substantially equal to a duration of second defined time interval t₂, and a duration of third time interval t₃ may be different to the duration of second defined time interval t₂. In such an example, the apparatus 100 may determine some characteristics of the data structures provided during the first and second defined time intervals, t₁ and t₂. For example, the apparatus 100 may determine that the false positive rate returned by the provided data structures exceeds a defined threshold and is unacceptably high. In such an example, the processor 104 may alter the duration of the defined time interval t₃ before the third defined time period t₃ has begun. Altering the third defined time interval t₃ may mitigate for negative effects that might have occurred in the third data structure 206, had the third defined time interval t₃ had a longer duration. In some examples, the processor 104 may alter the duration of any defined time interval of a continuous length of time.

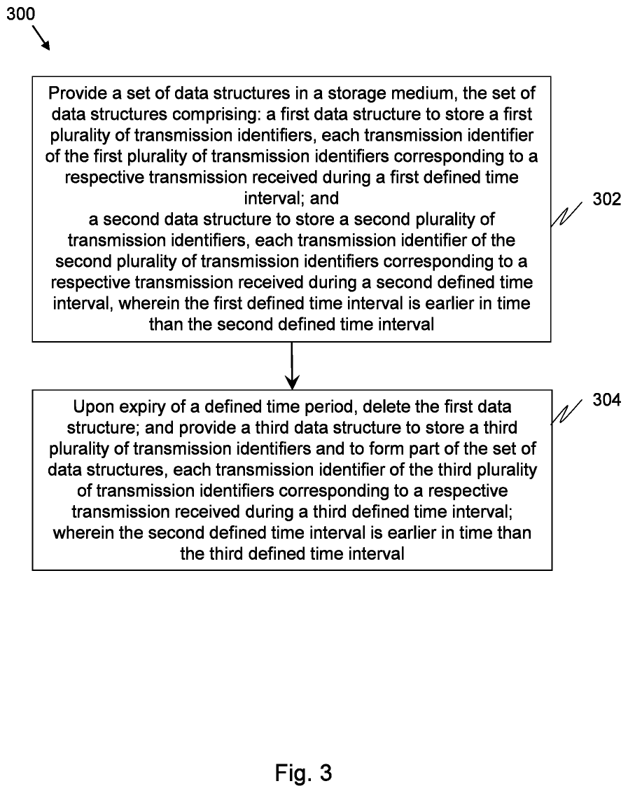

FIG. 3 illustrates a flowchart of an example of a method 300. The method 300 may, in some examples, be considered a method of data structure management, or a method of storing numerical identifiers in data structures. The method comprises, at block 302, providing a set of data structures in a storage medium, the set of data structures comprises a first data structure to store a first plurality of transmission identifiers, each transmission identifier of the first plurality of transmission identifiers corresponding to a respective transmission received during a first defined time interval; and a second data structure to store a second plurality of transmission identifiers, each transmission identifier of the second plurality of transmission identifiers corresponding to a respective transmission received during a second defined time interval. The first defined time interval is earlier in time than the second defined time interval. In one example, a transmission identifier may comprise a numerical identifier. In some examples, a transmission may comprise a signal. The method 300 further comprises, at block 304, upon expiry of a defined time period deleting the first data structure and providing a third data structure to store a third plurality of transmission identifiers and to form part of the set of data structures, each transmission identifier of the third plurality of transmission identifiers corresponding to a respective transmission received during a third defined time interval. The second defined time interval is earlier in time than the third defined time interval. Blocks of the method 300 may, for example, be performed using the apparatus 100 described above.

In some examples, the blocks 302, 304 of method 300 may be further broken down into more blocks. For example, the first data structure and the second data structure provided in block 302 may be provided in separate blocks or processes. In another example, deleting the first data structure and providing the third data structure in block 304 may be performed separately in separate blocks (e.g. as separate processes). In a further example, deleting the first data structure and providing the third data structure in block 304 may be performed substantially simultaneously.

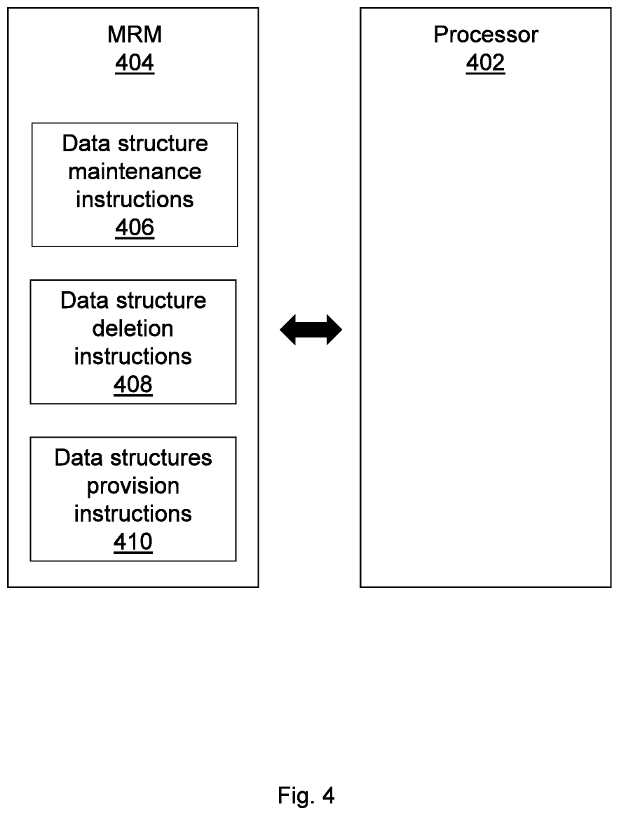

According to a further aspect, the present disclosure relates to a machine-readable medium. FIG. 4 is a simplified schematic of an example of a processor 402 and a machine-readable medium 404. The processor 402 and the machine-readable medium 404 may communicate with one another. The machine-readable medium 404 comprises instructions which, when executed by the processor 402, cause the processor to perform functions associated with blocks of the method 300 described herein. In some examples, the machine-readable medium 404 comprises instructions (e.g. data structure maintenance instructions 406) which, when executed by the processor 402, cause the processor to maintain a set of data structures, each data structure associated with a corresponding defined time interval; wherein each data structure comprises a respective plurality of numerical identifiers, each numerical identifier of the plurality corresponding to a respective signal received during the corresponding defined time interval. The machine-readable medium 404 comprises instructions (e.g. data structure deletion instructions 408 and data structure provision instructions 410) which, when executed by processor 402, cause the processor to, upon expiry of a defined time period, delete a first data structure associated with a first defined time interval from the set of data structures; and provide a second data structure associated with a second defined time interval to the set of data structures; wherein the first defined time interval is earlier in time than the second defined time interval.

The methods and apparatus disclosed herein provide an efficient process for managing data structures and managing the storage of numerical identifiers associated with nonces of received signal to help prevent replay attacks.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfill the functions of several units recited in the claims.

The features of any dependent claim may be combined with the features of any of the independent claims or other dependent claims.

1. An apparatus, comprising:
a storage medium to store:
a first data structure to receive a first plurality of numerical identifiers, each numerical identifier of the first plurality of numerical identifiers corresponding to a respective signal received during a first defined time interval; and
a second data structure to receive a second plurality of numerical identifiers, each numerical identifier of the second plurality of numerical identifiers corresponding to a respective signal received during a second defined time interval, wherein the first defined time interval is earlier in time than the second defined time interval; and
a processor;
wherein upon expiry of a defined time period, the processor is to:
delete the first data structure; and
provide a third data structure to receive a third plurality of numerical identifiers, each numerical identifier of the third plurality of numerical identifiers corresponding to a respective signal received during a third defined time interval occurring after the second defined time interval.

2. The apparatus of claim 1 wherein the defined time period comprises the first, second and/or third defined time interval.

3. The apparatus of claim 1 wherein the defined time period, the first defined time interval, the second defined time interval and the third defined time interval are substantially the same length.

4. The apparatus of claim 1 wherein a duration of the first defined time interval is substantially equal to a duration of the second defined time interval and a duration of the third defined time interval is different to the duration of the second defined time interval.

5. The apparatus of claim 1 wherein the first defined time interval, the second defined time interval and the third defined time interval are consecutive intervals of time.

6. The apparatus of claim 1 wherein the first and second data structures, when stored in the storage medium, form part of a set of data structures corresponding to a set of respective defined time intervals and the first defined time interval corresponds to an earliest occurring defined time interval of the set of respective defined time intervals.

7. The apparatus of claim 1 wherein upon receiving, during the second time interval a signal including data and a time indication element indicating a time at which the signal was sent, the processor is to:
determine whether the time at which the signal was sent corresponds to a time falling within the first defined time interval or the second defined time interval; and
responsive to determining that the time at which the signal was sent does not correspond to a time in the first defined time interval or the second defined time interval, reject the signal.

8. The apparatus of claim 1 wherein upon receiving, during the second time interval, a signal including data, a signal identifier associated with the received signal and a time indication element indicating a time at which the signal was sent, the processor is to:
determine whether the time at which the signal was sent corresponds to a time in the first defined time interval or the second defined time interval;
responsive to determining that the time at which the signal was sent corresponds to a time in the first defined time interval or the second defined time interval, search the first data structure and the second data structure for a numerical identifier corresponding to the signal identifier; and
responsive to determining that the signal identifier corresponds to a numerical identifier in either the first data structure or the second data structure, reject the signal.

9. The apparatus of claim 1 wherein upon receiving, during the second time interval, a signal including data, a signal identifier associated with the received signal and a time indication element indicating a time at which the signal was sent, the processor is to:
determine whether the time at which the signal was sent corresponds to a time in the first defined time interval or the second defined time interval;
responsive to determining that the time at which the signal was sent corresponds to a time in the first defined time interval or the second defined time interval; search the first data structure and the second data structure for a numerical identifier corresponding to the signal identifier; and
responsive to determining that the signal identifier does not correspond to a numerical identifier in the first data structure or the second data structure, add a new numerical identifier, corresponding to the signal identifier, to the second data structure.

10. The apparatus of claim 1 wherein each numerical identifier of the first, second and/or third data structures corresponds to a portion of a signal identifier included in each respective received signal.

11. The apparatus of claim 1 wherein each received signal comprises a respective nonce; and wherein a numerical identifier corresponding to a received signal comprises at least a portion of the respective nonce.

12. The apparatus of claim 1 wherein the storage medium is to store a set of data structures, each data structure corresponding to a respective defined time interval of a plurality of defined time intervals, and wherein the first, second and/or third data structures, when stored in the storage medium, are to form part of the set of data structures; and
wherein the processor, based on the defined time period, is to periodically:
delete an oldest data structure of the plurality of data structures corresponding to an oldest defined time interval of the plurality of defined time intervals; and
provide a new data structure to the plurality of data structures corresponding to a latest time interval forming part of the plurality of defined time intervals.

13. The apparatus of claim 1 wherein the defined period of time is based on an error between a clock associated with the apparatus and a clock associated with a signal device sending a signal to the apparatus.

14. A method, comprising:
providing a set of data structures in a storage medium, the set of data structures comprising:
a first data structure to store a first plurality of transmission identifiers, each transmission identifier of the first plurality of transmission identifiers corresponding to a respective transmission received during a first defined time interval; and
a second data structure to store a second plurality of transmission identifiers, each transmission identifier of the second plurality of transmission identifiers corresponding to a respective transmission received during a second defined time interval, wherein the first defined time interval is earlier in time than the second defined time interval;
upon expiry of a defined period of time, deleting the first data structure and providing a third data structure to store a third plurality of transmission identifiers and to form part of the set of data structures, each transmission identifier of the third plurality of transmission identifiers corresponding to a respective transmission received during a third defined time interval;
wherein the second defined time interval is earlier in time than the third defined time interval.

15. A machine-readable medium comprising instructions which, when executed by a processor, cause the processor to:
maintain a set of data structures, each data structure associated with a corresponding defined time interval; wherein each data structure comprises a respective plurality of numerical identifiers, each numerical identifier of the plurality corresponding to a respective signal received during the corresponding defined time interval; and
upon expiry of a defined time period:
delete a first data structure associated with a first defined time interval from the set of data structures; and
provide a second data structure associated with a second defined time interval to the set of data structures;
wherein the first defined time interval is earlier in time than the second defined time interval.
